(19) United States
(12) Patent Application Publication
(10) Pub. No.: US 2008/0086374 A1
(43) Pub. Date: Apr. 10, 2008

(54) NUTRITION MANAGEMENT AND MEAL PLANNING PROGRAM

(75) Inventors: Stuart Aitken, Pleasanton, CA (US); Warren Lee, Mountain View, CA (US); Kaushik Subramanian, Fremont, CA (US); Jonathan Quinn, San Mateo, CA (US)

Correspondence Address: CONLEY ROSE, P.C., 5601 GRANITE PARKWAY, SUITE 750, PLANO, TX, 75024, US

(73) Assignee: Safeway, Inc., Pleasanton, CA (US)

(21) Appl. No.: 11/749,672

(22) Filed: May 16, 2007

Related U.S. Application Data
(63) Continuation-in-part of application No. 11/560,930, filed on Nov. 17, 2006.
(60) Provisional application No. 60/828,495, filed on Oct. 6, 2006.

(51) Int. Cl. G06Q 30/00

(52) U.S. Cl. 705/14

(57) ABSTRACT

In one embodiment, computerized systems and methods for nutritional planning are disclosed that may comprise providing a database coupled to a central terminal, storing in the database a plurality of records comprising nutritional information related to products available for purchase using a loyalty profile, and associating in the database the nutritional information with products purchased using the loyalty profile. These systems and methods may further comprise identifying deficiencies in a nutritional profile and displaying products which compensate for deficiencies.

### CROSS-REFERENCE TO RELATED APPLICATIONS

This application claims priority under 35 U.S.C. §119(e) to U.S. Patent Application Ser. No. 60/828,495 filed on Oct. 6, 2006 and entitled “Nutrition Management and Meal Planning Program.” The present application is also a Continuation-in-Part application to U.S. patent application Ser. No. 11/560,930 filed on Nov. 17, 2006 and entitled “Nutrition Management and Meal Planning Program.” Each of the above applications is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates to the creation of customized nutritional purchase information, and more specifically to the creation of nutritional reports, nutritional options, and promotional information based upon purchases at a local store or online store made while using a loyalty card.

### BACKGROUND

Loyalty cards are one way to offer incentives for consumers to return to a particular company. For instance, a store may reward its consumers with financial bonuses or discounts which may be applied to purchases. In addition to the enhanced consumer loyalty, the company obtains information on consumers' purchasing behavior.

While the information obtained on the consumers purchasing behavior is useful by the company, there has not been a way to provide the consumer with useful information based upon information that has been obtained. This problem is perhaps most evident in grocery stores, where nutrition information is freely available for individual products, but is not aggregated in a way that is useful to a consumer.

### SUMMARY

In one embodiment, a computerized method for nutritional planning is disclosed which comprises providing a database coupled to a central terminal, storing in the database a plurality of records comprising nutritional information related to products available for purchase using a loyalty profile, and associating in the database the nutritional information with products purchased using the loyalty profile. This method further comprises identifying deficiencies in a nutritional profile and displaying products which compensate for deficiencies.

In another embodiment, a computer-readable medium encoded with a computer program code for managing nutrition planning data is disclosed, the program code causing a computer to execute a method comprising controlling a first database, a second database, and a third database with a central processor, storing in the first database a plurality of records comprising loyalty card data for at least one loyalty card profile, and storing in the second database a plurality of records comprising product information of products purchased using the loyalty card profile. This method further comprises storing in a third database a plurality of records comprising nutritional intake guidelines, receiving at the central processor a request to display information which relates to the loyalty card profile and product information, generating a report by aggregating data from the second database with the loyalty card profile found in the first database, and comparing the report with the nutritional intake guidelines.

In yet another embodiment, a system for managing nutritional plan data is disclosed which comprises a database coupled to a central processor, a storage module configured to store in the database a plurality of records comprising loyalty card data for products purchased with a loyalty card and nutritional information for products available for purchase with the loyalty card, a data processing module configured to compare products purchased with a loyalty card with the nutritional information for products available for purchase with the loyalty card, determine deficiencies as determined by a standardized measurement, and propose products which compensate for deficiencies, and an output module for transmitting results, wherein the central processor is configured to receive a request for nutritional information regarding products purchased with the loyalty card and generates a report based upon the nutritional information found in the database of the products purchased with the loyalty card.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is an overview of one embodiment of the present disclosure.

FIG. 2 is a flowchart of one embodiment of the creation of a consumer profile.

FIG. 3 is a flowchart of one embodiment of the creation of a report based upon a consumer profile.

FIG. 4 is a flowchart of one embodiment of the creation of a customized report preference by a consumer.

FIG. 5 is a block diagram of one embodiment of the present disclosure.

FIG. 6 is a chart illustrating nutritional purchase and consumption information.

FIG. 7 is a chart illustrating nutritional details.

FIG. 8 is a screen shot of one embodiment of the present disclosure showing report results.

FIG. 9 is a screen shot of one embodiment of the present disclosure illustrating a trend chart.

FIG. 10 is a flowchart of one embodiment of a method of selecting recipes for meal planning.

FIG. 11 is a screenshot illustrating the choices of recipes.

FIG. 12 is a screenshot illustrating the choices of food items.

FIG. 13 is a flowchart of a method of evaluating recipe choices.

FIG. 14 is a screenshot of a revised nutrition trend chart based upon recipe choices.

FIG. 15 is a screenshot of a shopping list.

FIG. 16 is a screenshot of a store map illustrating the location of local stores.

FIG. 17 is a screen shot of a store map illustrating where to purchase items in a local store.

FIG. 18 is a screenshot of an input screen.

FIG. 19 is a screenshot of a recommendation screen.

FIG. 20 illustrates an exemplary general purpose computer system suitable for implementing the several embodiments of the disclosure.

### DETAILED DESCRIPTION

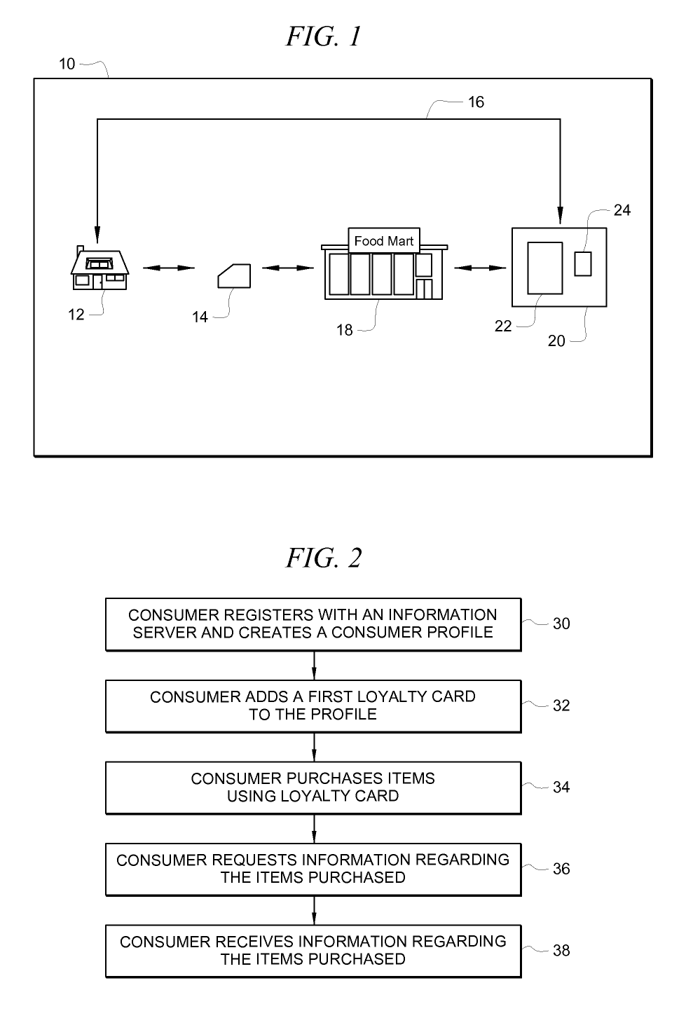

In an embodiment shown in FIG. 1, the nutrition management and meal planning program 10 contains a consumer 12, a loyalty card 14, a network connection 16, a store 18, an informational computer 20, and a nutritional database 22. Consumer 12 registers a first loyalty card 14 for example by using network connection 16 or otherwise providing such information, with informational computer 20 and creating loyalty profile 24. Consumer 12 uses loyalty card 14 at store 18 while making purchases. Informational computer 20 records the purchases of consumer 12. When consumer 12 accesses informational computer 20 and requests information regarding loyalty profile 24, informational computer 20 matches products sold at store 18 with information from nutritional database 22 and generates a report based upon the purchases of consumer 12. The report created by informational computer 20 is then provided, for example transmitted through network connection 16, to consumer 12. This report may contain information including, but not limited to, nutritional management information (e.g., nutrition information on household purchases which can be used to benchmark product nutrition information against daily recommended intake for various nutrients), product alternative information (e.g., suggestions for alternative products that can be based on nutritional goals, health information, or for other reasons disclosed herein), meal planning (e.g., recipes that align with food preferences and nutritional goals), promotional information (e.g., items that may be used with the meal planning information), local store information (e.g., map of local store and location of items within the store), and other information as disclosed herein. Network connection 16 may be any network capable of transmitting and receiving data including, but not limited to, internet, postal, and telephone networks. It should be understood that the registration of loyalty profile 24 and the purchasing of products may be performed in any order or concurrently. It should also be understood that store 18 may be a local store, such as a grocery store which is intended to refer to any location physically visited by consumer 12, or an online store visited by consumer 12 through a computer terminal or other electronic device.

While FIG. 1 illustrates a single consumer 12, loyalty card 14, and store 18 it is envisioned that a plurality of consumers may use a plurality of loyalty cards at a plurality of stores linked to a single loyalty profile 24. It is further envisioned that any number of stores could be used by informational computer 20 to collect information about the purchases of consumer 12. The examples of consumer 12, loyalty card 14, and store 18 are therefore intended to be illustrative and not limiting.

FIG. 2 is an example of one embodiment of the process by which consumer 12 may register one or more loyalty cards with informational computer 20 (Block 30). Consumer 12 communicates directly or indirectly with informational computer 20 and creates loyalty profile 24 through network connection 16. Loyalty profile 24 may include, but is not limited to the following information about individuals using loyalty profile 24: gender, name, age, and activity level. Using the gender, name, age, activity level, informational server 20 is capable of determining the recommended daily intake for nutrients including, but not limited to, calories using industry accepted guidelines and other methods known to one skilled in the art. Two examples of industry accepted guidelines are the daily recommended intake of calories as set by the Food and Drug Administration (FDA) and the United States Department of Agriculture (USDA) Dietary Guidelines. Loyalty profile 24 also contains information regarding the identity and quantity of products purchased using loyalty card 14.

Consumer 12 can add a loyalty card 14 to the loyalty profile 24 (Block 32). In the example shown in FIG. 2, loyalty card 14 is registered using network connection 16. However, it is explicitly understood that loyalty card 14 could be registered in any number of other ways, including, but not limited to, filling out a registration form at store 18. It is further understood that store 18 may, in some alternative embodiments, directly input loyalty profile 24 into informational computer 20.

When consumer 12 purchases products from store 18 using loyalty card 14 linked to loyalty profile 24, informational computer 20 automatically updates loyalty profile 24 with purchases made with loyalty card 14 (Block 34). Consumer 12 can access informational computer 20 and request information about the products purchased through network 16 (Block 36). The consumer 12 can also receive information regarding the products purchased with loyalty card 14 (Block 38). The information received by consumer 12 may include, but is not limited to, information regarding nutritional information of products purchased, alternatives to products purchased, methods of preparation of products purchased, and other promotional or informational material. The information that consumer 12 receives may be transmitted via email, displayed on a local web browser, transmitted through telephonic communication (e.g., facsimile transmission), presented at a point of sale or purchase, or in other ways known to one skilled in the art.

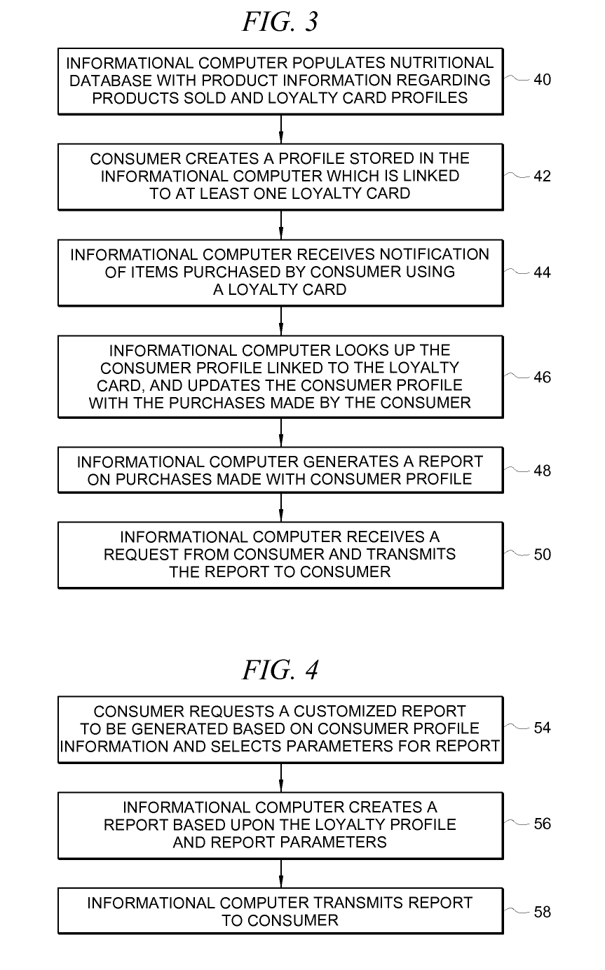

FIG. 3 is a flowchart of one embodiment where informational computer 20 creates nutritional database 22 and creates a report for consumer 12. Informational computer 20 populates nutritional database 22 with product information regarding products sold at store 18 (Block 40). This information may be provided by manufactures, distributors, the USDA, the FDA, or any other source known to one skilled in the art. Consumer 12 creates loyalty profile 24 which is stored in informational computer 20 and is linked to at least one loyalty card 14 (Block 42). Loyalty profile 24 may be created in any manner discussed above, and may be created prior, concurrent, or subsequent to the population of nutritional database 22. Informational computer 20 receives notification of items purchased by consumer 12 using loyalty card 14 (Block 44). Such notification may be made in any way known to one skilled in the art, including, but not limited to, point of sale data. This data could, in one embodiment, be obtained through collecting data from the scanning of items sold, capturing this data, and transmitting this data to informational computer 20. Informational computer 20 looks up the loyalty profile 24 linked to loyalty card 14, and updates loyalty profile 24 with information related to the purchases made by consumer 12 (Block 46). This purchasing information may include, but is not limited to, the type and quantity of products purchased, information identifying loyalty card 14, and other sales information. Informational computer 20 generates a report on purchases made by consumer 12 using the loyalty profile 24 (Block 48). It is expressly contemplated that consumer 12 may modify loyalty profile 24 with additional products purchase, or by removing items listed in loyalty profile 24. In this embodiment, the informational computer 20 automatically generates a report upon the receipt of information by store 18; however, it is contemplated that the report may be generated at any time as discussed above. When informational computer 20 receives a request from consumer 12 linked to loyalty profile 24, it transmits the report based on loyalty profile 24 to consumer 12 (Block 50).

FIG. 4 is a flowchart of one embodiment where a consumer can create a customized report. First, the consumer requests a customized report to be generated based on loyalty profile information, and selects parameters for the report (Block 54). Parameters for the report include, but are not limited to, the purchased products consumer 12 is interested in (e.g. breads, fruits, and candy), and the nutritional content of purchased products (e.g. calcium, protein, and fat). Informational computer 20 creates a report based upon the loyalty profile 24 and report parameters (Block 56). Informational computer 20 transmits the report to consumer 12 (Block 58).

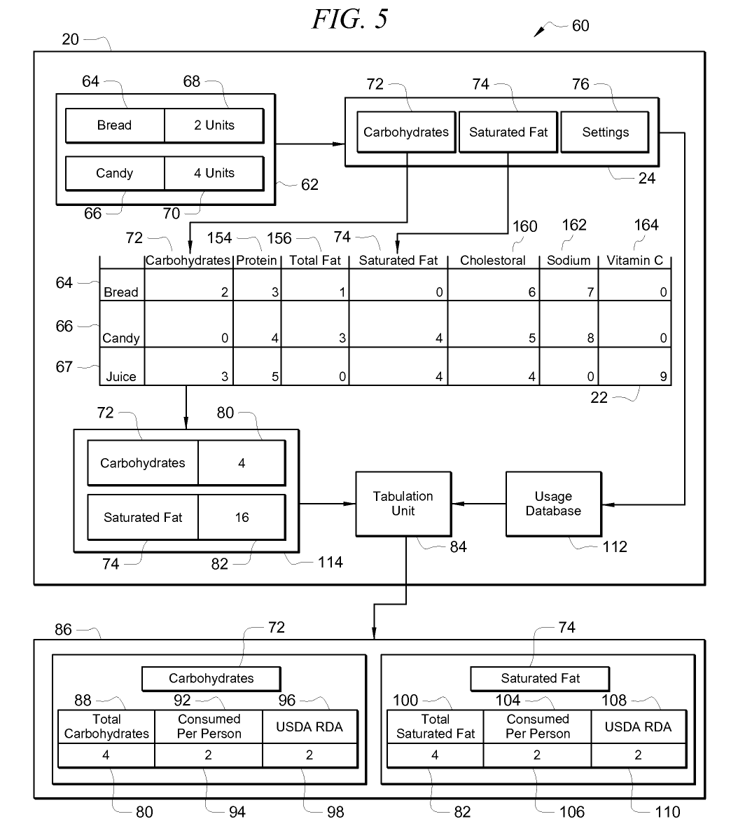

FIG. 5 is a block diagram 60 of one embodiment where informational computer 20 takes information from a sales log 62 and loyalty profile 24, looks up information in nutritional database 22, and creates a preliminary report 114. Informational computer 20 also looks up information related to loyalty profile 24 in usage database 112, combines the information from usage database 112 with information from loyalty profile 24 in tabulation unit 84 and creates report 86. It should be understood that the products shown in this figure are for illustrative purposes only. For instance, any number of products may be purchased by consumer 12 and recorded in sales log 62, loyalty profile 24 may contain any number of customized settings, and nutritional database 22 may contain any number of products and any number of elements pertaining to each item. It is further contemplated that informational computer 20 may combine one or more products, such as combining nutritional database 22, usage database 112, and tabulation unit 84 into a single unit.

Sales log 62 shows that consumer 12 purchased two units 68 of bread 64 and four units 70 of candy 66. Sales log 62 may also include other information, such as the date of purchase, the method of payment, and identifying the loyalty card used during the transaction in which sales log 62 was created. Sales log 62 may identify products sold in any number of different ways, including, but not limited to, recording the UPC of each item, a serial number for each item, or in any number of ways known to one skilled in the art. Sales log 62 may be created through any method known to one skilled in the art, including, but not limited to, recording items scanned at the point of sale, and listing these items in sales log 62.

Loyalty profile 24 indicates that consumer 12 is interested in tracking carbohydrates 72 and saturated fat 74. It is contemplated that loyalty profile 24 contains records of all sales, including those recorded by sales log 62, where loyalty card 14 was used to make a purchase as well as any other information entered into consumer profile 24 by consumer 12. While two elements, carbohydrates 72 and saturated fat 74 are shown, it is understood that any number of elements may be designated by the consumer, a predestinated set of elements may be selected by store 18 or consumer 12, or that all available entries in nutritional database 22 may be used. It is further contemplated that settings 76 include, but are not limited to, information regarding nutritional information of products purchased, methods of preparation of products purchased, and possible alternatives to products purchased. For exemplary purposes only, it will be assumed that loyalty profile 24 information contains information relating to two individuals in this illustrative example.

In this embodiment, nutritional database 22 contains information about the following products: bread 64, candy 66, and juice 67. For each of these products, nutritional database 22 contains information about the elements carbohydrates 72, protein 154, total fat 156, saturated fat 74, cholesterol 160, sodium 162 and vitamin C 164. For the purpose of clarity, the term products is intended to refer to any item which is sold and may appear in sales log 62, and the term element is to refer a property of a product. Nutritional database 22 is intended to be illustrative only, as it is contemplated that any number of products may be present within the database, and any number of elements may describe the products.

Informational computer 20 aggregates information from sales log 62 and loyalty profile 24 to create preliminary report 114. Preliminary report 114 contains information about carbohydrates total 80 and saturated fat total 82. In this example, there are a total of four units 80 of carbohydrates 72, and sixteen units 82 of saturated fats 74. It is understood that preliminary report 114 may also contain information regarding the number of individuals, activity levels, or other items listed in loyalty profile 24, as well as the time period in which it is expected that the products purchased in sales log 62 will be consumed. This preliminary report may also take into consideration other items, including, but not limited to, the number of meals that an individual in loyalty profile 24 is scheduled to eat, and pass this information to usage database 112.

Usage database 112 may contain information including, but not limited to, the recommended daily allowance of elements, information about certain foods, and other information which may be available. The usage database 112 may be populated from the USDA, FDA, or other sources of information. It is contemplated that usage database 112 may also contain additional information about foods, such as possible health warnings.

Tabulation unit 84 uses information from preliminary report 114 and usage database 112 to create report 86. Tabulation unit 84 is also capable of adding other additional information including, but not limited to, promotional information, methods of preparation of products purchased, alternatives to products purchased, as well other forms of information. Tabulation unit 84 may also perform other functions, such as examining all products purchased as reflected by loyalty profile 24, matching those products against usage database 112, and adding possible nutrient deficiencies to report 86. For instance, if the FDA recommends a particular amount of vitamin C, and none is found within loyalty profile 24, it could alert consumer 12 to the deficiency. In addition, if consumer 12 had an unsafe amount of sodium 162, tabulation unit 84 could pass a message listed in the FDA into report 86. It is contemplated that other sources of information, including, but not limited to, the American Medical Association could be made part of usage database 112.

Report 86 shows the results of the information gathered by tabulation unit 84. Since consumer 12, in this embodiment, has indicated a desire to track usage of carbohydrates 72 and saturated fat 74, report 86 will list these items. As previously indicated, loyalty profile 24 has shown that there are two individuals who are using loyalty profile 24. The generated report shows that there are four units 80 of total carbohydrates 88, two units 94 of which are consumed per person 92, and the USDA recommended daily allowance 96 is two units 98. The generated report also shows that there are sixteen units 82 of saturated fat 74, eight units 106 of which are consumed per person 104, and the USDA recommended daily allowance 108 is two units 110. One of the advantages of the disclosed innovations is the ability to tabulate sales log 62 into the loyalty profile 24, compare this information with third party recommendations, and providing consumer 12 with nutritional information.

Tabulation unit 84 is further capable of performing comparative analysis. Comparative analysis is intended to include, but not be limited to, the process by which tabulation unit 84 compares the amount of each element purchased divided by a factor, such as the USDA recommended daily allowance. This provides consumer 12 with a result that illustrates the proportion of items purchased (e.g. a first number of days of a first food element and a second number of days of a second food element.) This comparative analysis may be customized by consumer 12 using loyalty profile 24. This customization includes, but is not limited to, indicating consumption habits using loyalty profile 24. Comparative analysis allows the consumer to determine the relative amount of each element purchased as adjusted by dietary guidelines.

Another innovative feature of the present disclosure is the ability to refresh report 86 and allow consumer 12, loyalty profile 24, or other entity to create alert thresholds. For instance, the consumer 12 may want to be alerted when saturated fat 82 is consumed in an unhealthy amount. Another example of an alert would be if store 18 becomes aware of a problem with an item purchased by consumer 12, a warning may be sent to consumer 12.

Yet another innovative feature of the present disclosure is the ability for a report to be created over an extended period of time, taking into account changes in diet, age, and activity level. For instance, consumer 12 requirements for carbohydrates 72 can change as activity level, age, and diet changes. This embodiment, by using the aforementioned method of calculating percentages, may create a report wherein the consumer is able to see a long term carbohydrates 72, or any other item, intake trend while taking into account these changing factors. Consumer 12 can customize a report to be generated over any period of time, taking into account any number of factors part of loyalty profile 24.

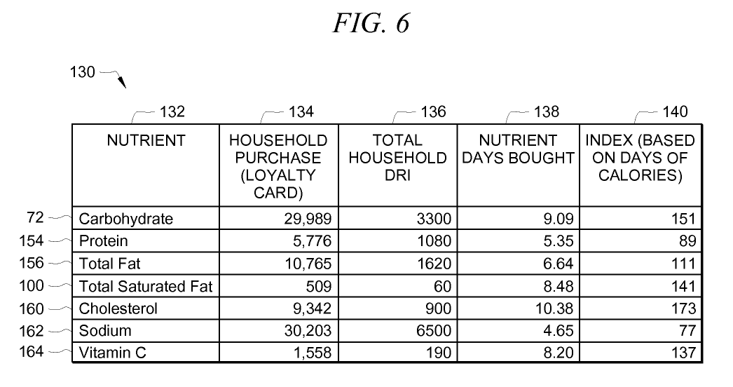

FIG. 6 is an example of nutritional spreadsheet 130 that may be created by informational computer 20. Nutritional spreadsheet 130 contains information including, but not limited to, the carbohydrates 72, protein 154, total fat 156, total saturated fat 100, cholesterol 160, sodium 162, and vitamin C 164. The examples of contents of nutritional spreadsheet 130 are given for exemplary purposes only, and this information should not be construed to limit what products may be listed in nutritional spreadsheet 130. This information may include, but is not limited to, columns for an identifier for the nutrient 132, the household aggregate purchase 134, the total daily recommended intake 136, the number of days for which the nutrient was purchased 138, and an index number 140. It is understood that index number 140 may correspond to FDA, USDA, or other third party recommendations.

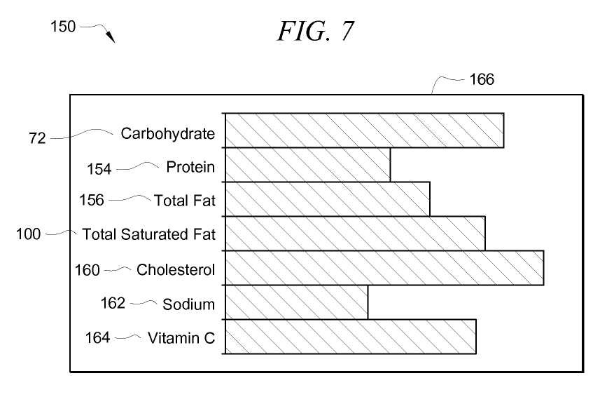

FIG. 7 is an example of a nutritional chart 150 created from nutritional spreadsheet 130 which contains information including, but not limited to, the carbohydrates 72, protein 154, total fat 156, total saturated fat 100, cholesterol 160, sodium 162, and vitamin C 164. In this example, the index value is plotted and a visual line at the recommended index line 166 is shown. This chart may create a way to graphically represent aggregate nutritional data to consumer 12.

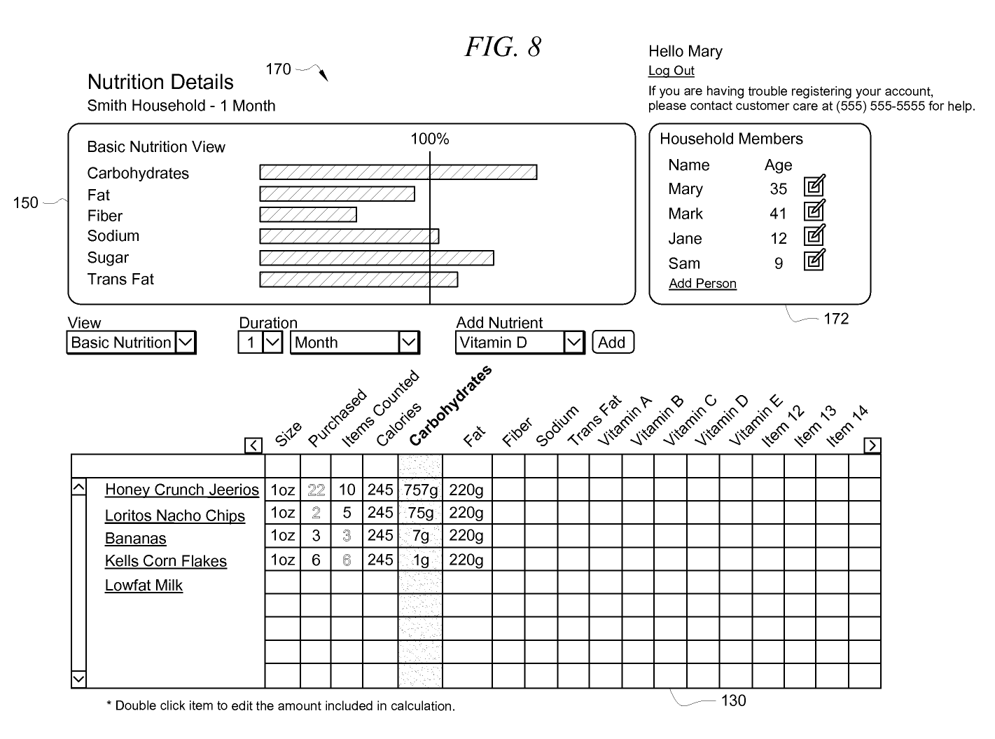

FIG. 8 is a first screen shot 170 which may be displayed on a personal computer used by consumer 12 that could be used in one of the disclosed embodiments. In this embodiment, nutritional spreadsheet 130, nutritional chart 150 and displayed profile information 172 related to loyalty profile 24 is displayed. This screenshot illustrates how nutritional management and meal planning program 10 is capable of aggregating data from loyalty profile 24 into a user accessible format.

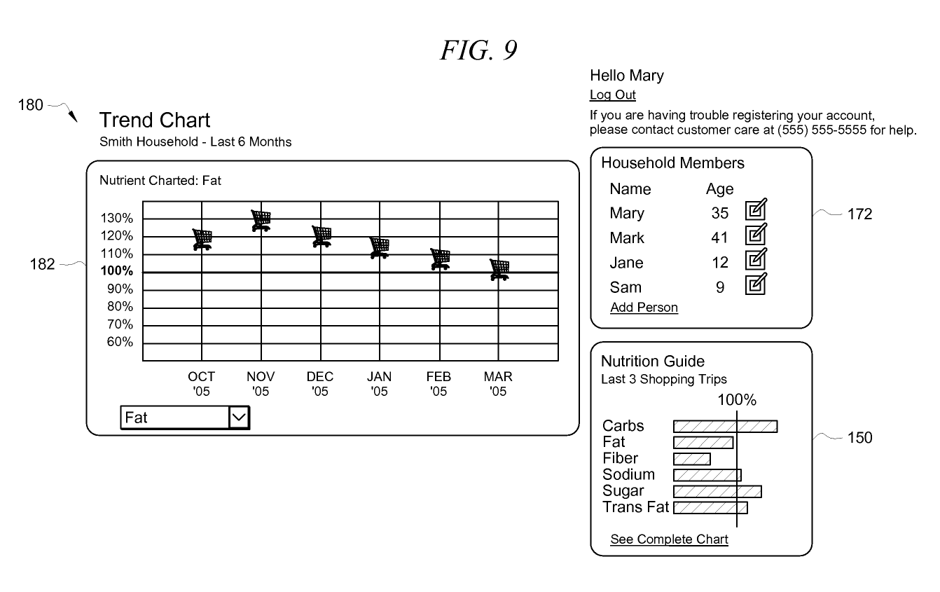

FIG. 9 is a second screen shot 180 which displays a customized report. In this example, nutritional chart 150, displayed profile information 172, and trend graph 182 are displayed. Trend graph 182 is an example of a customized report, where consumer 12 has requested information regarding total fat 156 consumption. Using this chart, consumer 12 can compare the recommended intake of total fat 156 with the level recommended by the FDA, USDA, or other sources over a period of time. This example is given for illustrative purposes, as any number of items may be charted over any length of time.

In addition to the customized report mentioned in FIG. 9 containing items such as nutritional chart 150, displayed profile information 172, and trend graph 182, it is expressly contemplated that the customized report may also contain information related to the availability of items which meet recommended nutritional intake guidelines, the location of store 18, the location of items within store 18, and instructions for the preparation of meals using items which meet the nutritional intake guidelines. The phrase “nutritional intake guidelines” is intended to refer to a set of guidelines, such as the FDA recommended daily allowance (RDA). Nutritional intake guidelines include parameters including, but not limited to, the appropriate intake by consumer 12 of grains, sugars, vegetables, fruits, milk, meat, beans, and oils.

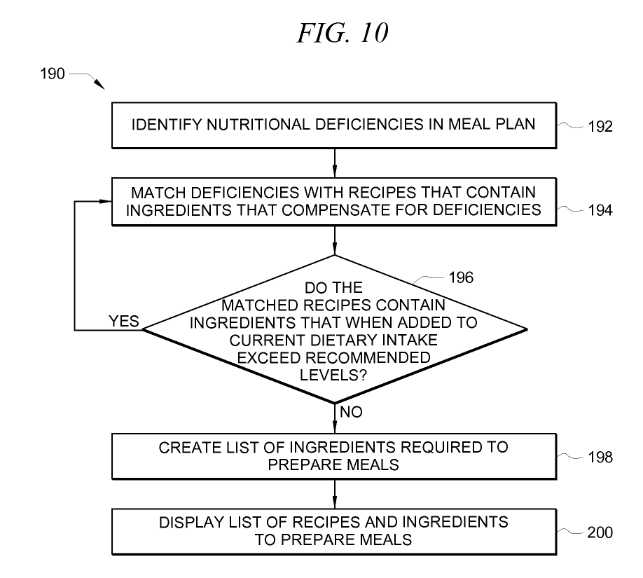

FIG. 10 is a flowchart of one method of finding meals that meet the requirements of a nutritional intake guideline. In this flowchart, tabulation unit 84 identifies nutritional deficiencies in meal plan (Block 192). One example of a deficiency in a meal plan might be an inadequate amount of protein as set forth in nutritional intake guidelines. Tabulation unit 84 matches deficiencies with recipes that contain ingredients that compensate for deficiencies (Block 194). For instance, if the deficiency is in protein, tabulation unit 84 may recommend a meal that contains beef. Tabulation unit 84 verifies that the matched recipes contain ingredients that when added to current dietary intake does not exceed recommended levels (Block 196). For instance, if recommended meals contain an unsafe level of cholesterol, tabulation unit 84 will look for alternative meals. If the proposed meals do not contain ingredients that exceed recommended levels, tabulation unit 84 creates a list of ingredients required to prepare the meals (Block 198). Tabulation unit 84 will then display a list of recipes and ingredients to prepare meals (Block 200).

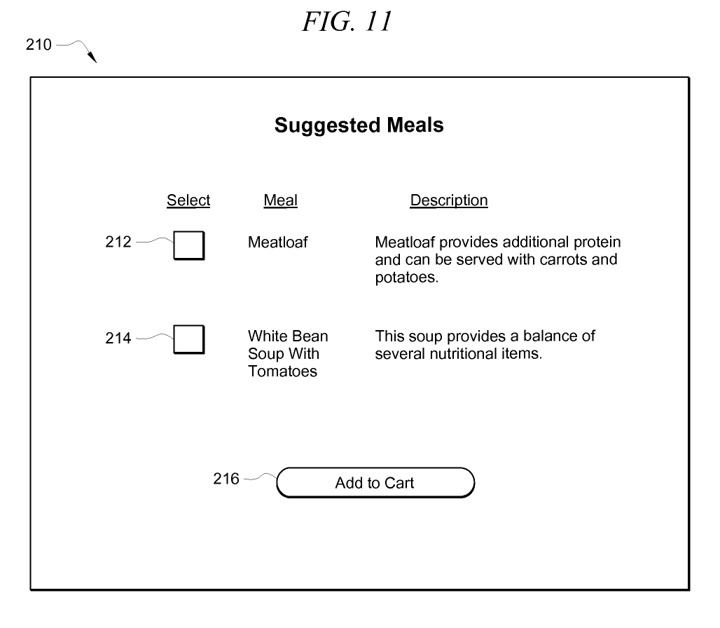

FIG. 11 is a screenshot 210 of suggested meals created by tabulation unit 84. In this screenshot, two meals are suggested. The first meal is meatloaf, and the second meal is white bean soup with tomatoes. It is contemplated that any number of meals may be suggested, and may be organized based on any factors including, but not limited to, analyzing prior buying habits to match existing purchased items with suggested meals in order to customize suggestions based on the user's preferences, the number of people needed to be served by a meal, or any other factor. In this screenshot, consumer 12 may select a first box 212 for meatloaf and a second box 214 for white bean soup with tomatoes. After the user makes a selection, consumer 12 may add the items to the user's shopping cart by selecting box 216.

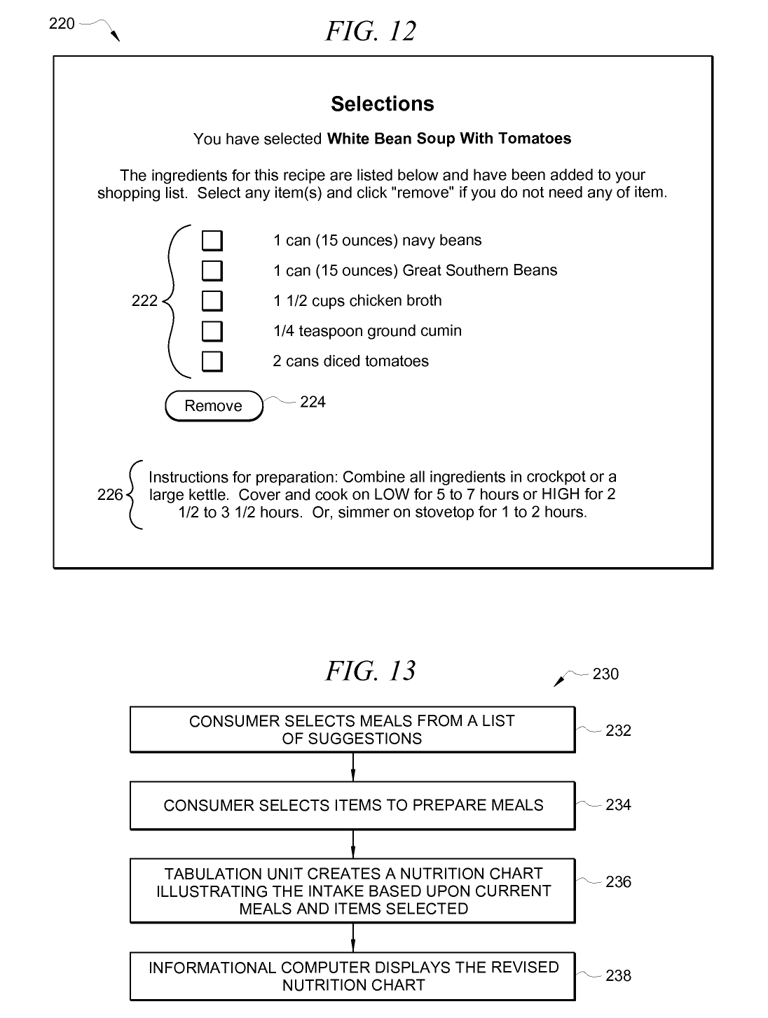

After consumer 12 makes a selection of a meal through an interface such as the one illustrated by FIG. 11, consumer 12 may be presented with a list of items used to make the meal such as screenshot 220 illustrated by FIG. 12. In this example, consumer 12 is shown the five items 222 required to make the recipe. If consumer 12 does not desire to purchase a particular item, that item may be selected and removed through the remove button 224. In addition to the ingredients being listed, instructions for preparation 226 may also be offered. It is contemplated that in some embodiments, an option will be given to consumer 12 to substitute certain items listed for other items with similar dietary properties. For instance, if a consumer prefers to use vegetable stock instead of chicken broth, tabulation unit 84 could account for this substitution. In addition, it is also contemplated that consumer 12, when removing an item from the list, could be prompted with a message asking if the removed item going to be used in the recipe, or if the removed item was to be excluded from the recipe. This information may be used in the profile of consumer 12 to better cater to personal preferences.

In addition to tracking previous nutritional intake, tabulation unit 84 may also be capable of projecting nutritional data based upon items in the nutritional chart. FIG. 13 is a flowchart 230 of one method of creating a nutrition chart based upon selected items. Consumer 12 selects meals from a list of suggestions as illustrated in FIG. 10 (Block 232). Consumer 12 then selects items to prepare meals (Block 234). It is envisioned that other options, such as allowing consumer 12 to specify the planned date of a meal, may also be made available. Tabulation unit 84 creates a new nutrition chart illustrating the intake based upon current meals and items selected (Block 236). Informational computer displays the revised nutrition chart (Block 238). One of the innovative features of the disclosed embodiments is the ability to actively plan meals in such a way that trend charts are used not only retrospectively to chart intake, but also prospectively to chart anticipated intake. This feature also allows consumer 12 to specific any duration in which to chart consumption (e.g. last six months, last year, last six months and project based upon current or anticipated purchase the next six months, etc.)

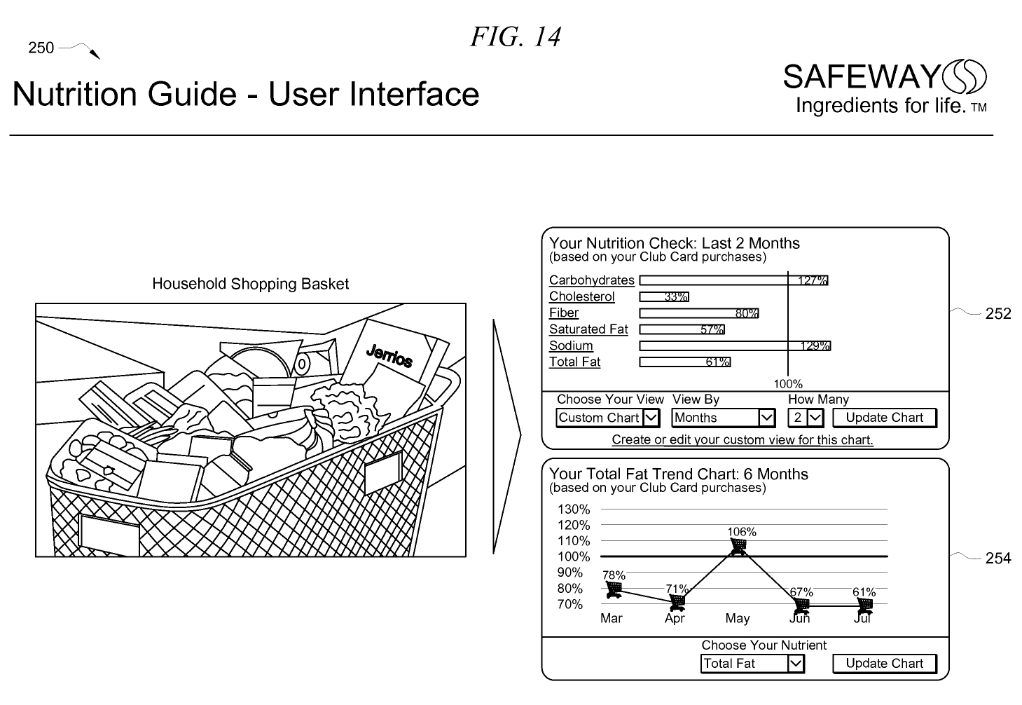

The nutrition chart created by a method such as the method illustrated by FIG. 13 is illustrated by the screenshot 250 shown in FIG. 14. In this example, the nutrition checklist 252 is recreated using the items selected by consumer 12. This provides consumer 12 an anticipated trend chart of intake based upon the meal decisions. Trend chart 254 illustrates that the consumption of fat will fall given the meal decisions made. Trend charts, such as trend chart 254, may be of any nutritional item using the history of purchased items as well as the meal planning features to show anticipated intake.

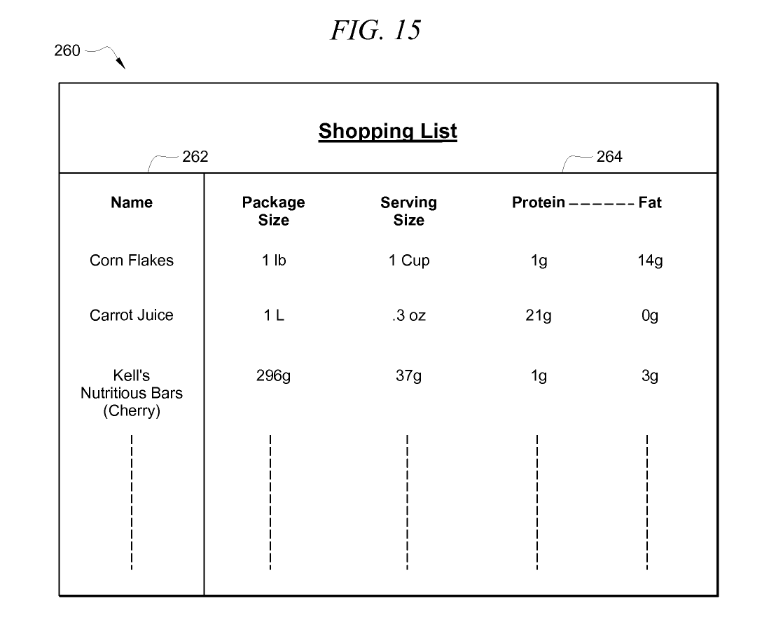

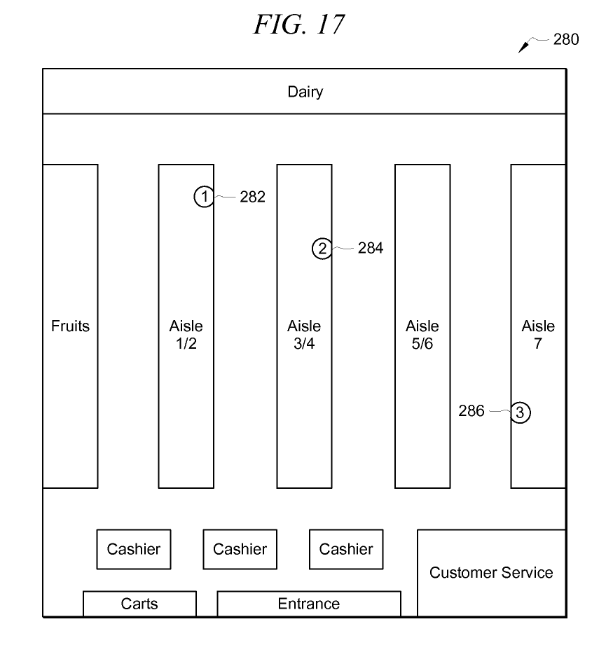

FIG. 15 is an illustration of a shopping list 260 created by tabulation unit 84 based upon consumer choices. Shopping list 260 may contain a first column 262 illustrating the name of the item, and a second set of columns 264 illustrating the nutritional contents of each item. The items may be numbered to correspond with other informational lists, such as a local store map that illustrates the location of items within a store. An example of the numbering of items to correspond with the location of items is illustrated in FIG. 17. In addition to creating a shopping list, promotional items may be added. These promotional items may be based upon current items in the shopping cart, previous items purchased, or any other factor programmed into tabulation unit 84.

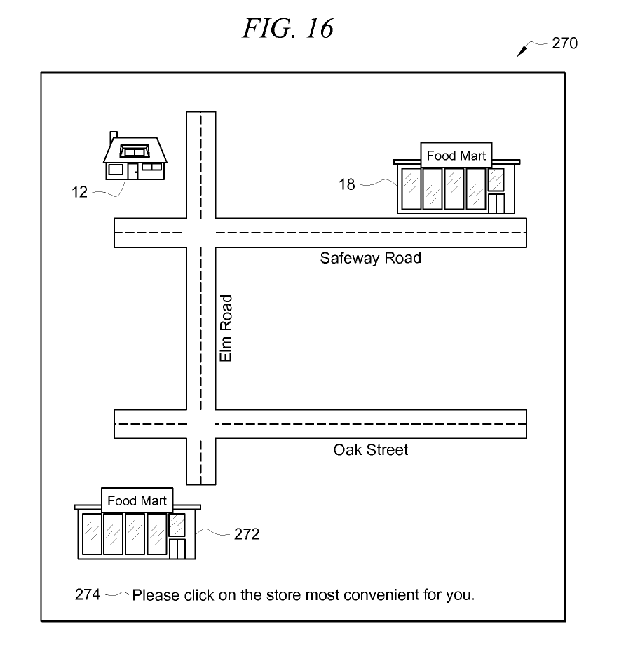

As shown in FIG. 16, once items have been selected, informational computer 20 may display a map 270 illustrating the location of local stores, including store 18 and a second store 272. Informational computer 20 can prompt 274 consumer 12 to select a store. This selection may enable informational computer 20 to create a customized map of a store that illustrates the location of items within the store. It is further contemplated that the consumer, in some embodiments, may be prompted to choose another option, such as the option to have the chosen items delivered, rather than choose a local physical store.

FIG. 17 is a store map 280 of a particular store 18 that illustrates the location of items numbered on shopping list 260. For instance, in this example, the first item 282 is located in aisle two, the second item 284 is located on aisle four, and the third item 286 is located on aisle seven. In this way, the consumer can obtain a detailed map illustrating the location of items within store 18 which are found in shopping list 260. This allows consumer 12 to quickly find the required items that correspond to the meal decisions made earlier.

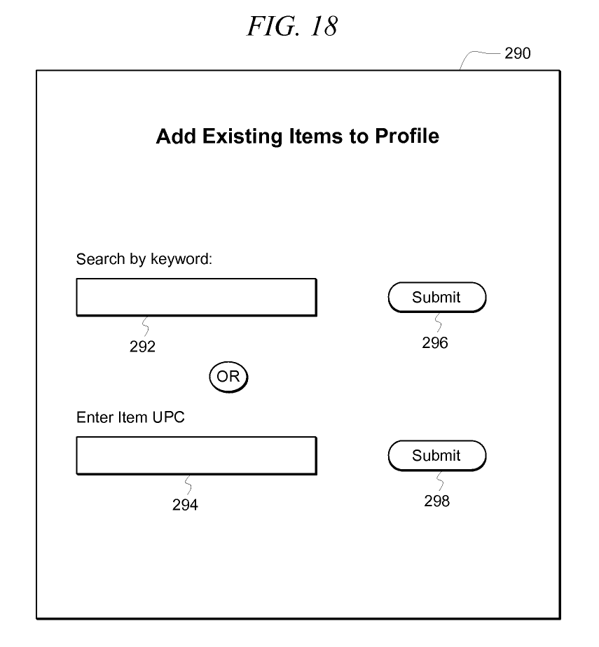

Another of the innovative features of the present application is the ability to take products that were obtained at any time and add these products to the loyalty profile. This addition of products may be done in any way known to one skilled in the art. This allows nutrition management and meal planning program 10 to accepting input from numerous sources, including, but not limited to, a web interface as illustrated by FIG. 18.

FIG. 18 is a screenshot 290 of a web screen that allows for a user to add existing products to a loyalty profile. In this example, the user is capable of entered a keyword into a box 292 and pressing a first submit button blue 296 to search for product that exists in the database. For instance, entering the brand name of a cereal might bring up all products in the database that relate to the cereal. Also in this example, the user can enter the universal product code (UPC) number into a UPC box 294 and pressing a second submit button 298 and have the existing item added directly to the loyalty profile.

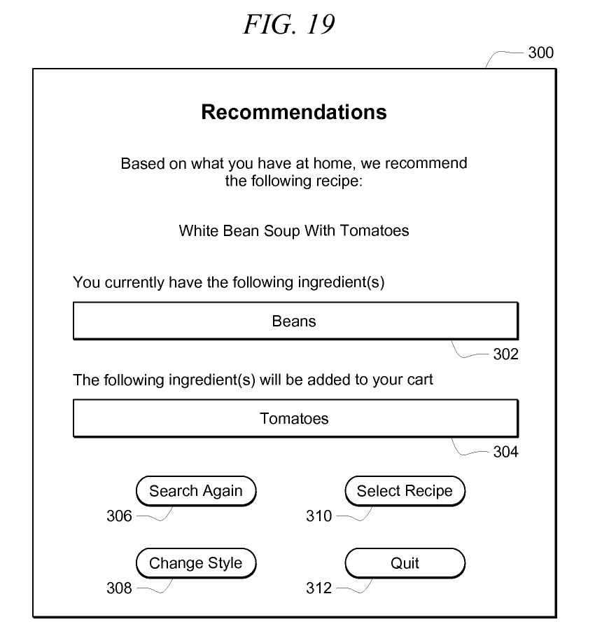

FIG. 19 is a screenshot 300 of the results of mixing together the ingredients already present along with ingredients to be added to a shopping list. In this example embodiment the to be added field 304 indicates that tomatoes will be added to the shopping card, as well as a field 302 which shows which items consumer 12 currently possesses. Consumer 12 is also presented with several options that may include searching for a different recipe 306, searching for a different style of recipe 308, and selecting the recipe 310. The phrase “style of recipe” is intended to include, but not be limited to, the type of cuisine (e.g. Tex-Mex, Italian, French, Indian, etc.) presented to consumer 12. An option 312 to quit is also offered.

It is expressly understood that consumer 12 may also be given additional information in screenshot 300, such as promotional materials, bundle offers, coupons, or any other information. It is further understood that some meals may be labeled “heart healthy” to indicate certain nutrition or dietary guidelines (e.g., low cholesterol, etc.) consistent with the previously mentioned methods of obtaining dietary information. It is expressly contemplated that the screenshot may be used to attempt to give consumer 12 new ways to use existing products, such as by trying a new type of cuisine which has previously not been presented to consumer 12.

It is explicitly understood that the recipe engine may contain any number of indicators, including, but not limited to indications for products which promote certain kind of health conditions (i.e. healthy heart, etc. It is further understood that the meal planning program may be used to customize reports for a particular type of nutrition styles, preferences, or needs. For instance, individuals that prefer a specific type of style of food (i.e. Cajun, etc.) may elect to view only recipies that are consistent with this type of food.

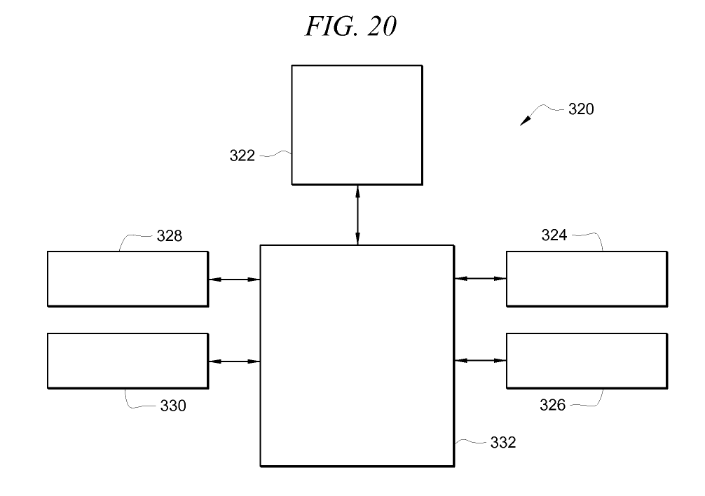

Informational computer 20 described above may be implemented on any general-purpose computer 320 with sufficient processing power, memory resources, and network throughput capability to handle the necessary workload placed upon it. A user home personal computer, networked to a central informational computer 20 through a wide area network, such as the Internet, may be used in conjunction with the disclosed embodiments. The user home personal computer may share some, or all, of the elements of informational computer 20. FIG. 20 illustrates a typical, general-purpose computer system suitable for implementing one or more embodiments disclosed herein. The general-purpose computer 320 includes a processor 332 (which may be referred to as a central processor unit or CPU) that is in communication with memory devices including secondary storage 322, read only memory (ROM) 324, random access memory (RAM) 326, input/output (I/O) 328 devices, and network connectivity devices 330. The processor may be implemented as one or more CPU chips.

The secondary storage 322 is typically comprised of one or more disk drives or tape drives and is used for non-volatile storage of data and as an over-flow data storage device if RAM 326 is not large enough to hold all working data. Secondary storage 322 may be used to store programs that are loaded into RAM 326 when such programs are selected for execution. The ROM 324 is used to store instructions and perhaps data that are read during program execution. ROM 324 is a non-volatile memory device that typically has a small memory capacity relative to the larger memory capacity of secondary storage. The RAM 326 is used to store volatile data and perhaps to store instructions. Access to both ROM 324 and RAM 326 is typically faster than to secondary storage 322.

I/O 328 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 330 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices 330 may enable the processor 332 to communicate with an Internet or one or more intranets. With such a network connection, it is contemplated that the processor 332 might receive information from the network, or might output information to the network in the course of performing the above-described method steps. Such information, which is often represented as a sequence of instructions to be executed using processor 332, may be received from and outputted to the network, for example, in the form of a computer data signal embodied in a carrier wave.

Such information, which may include data or instructions to be executed using processor 332 for example, may be received from and outputted to the network, for example, in the form of a computer data baseband signal or signal embodied in a carrier wave. The baseband signal or signal embodied in the carrier wave generated by the network connectivity devices 330 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 332 executes instructions, codes, computer programs, scripts that it accesses from hard disk, floppy disk, optical disk (these various disk based systems may all be considered secondary storage 322), ROM 324, RAM 326, or the network connectivity devices 330.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What we claim as our invention is:

1. A computerized method for nutritional planning, the method comprising:
providing a database coupled to a central terminal;
storing in the database a plurality of records comprising nutritional information related to products available for purchase using a loyalty profile;
associating in the database the nutritional information related to products available for purchase using the loyalty profile with products purchased using the loyalty profile;
identifying deficiencies in the products purchased with the loyalty profile based upon standardized intake guidelines; and
displaying products available which compensate for deficiencies.

2. The method of claim 1, further comprising using at least one loyalty card to access the loyalty profile.

3. The method of claim 1, further comprising sending the nutritional information associated with the loyalty profile to a networked remote terminal through electronic mail.

4. The method of claim 1, wherein the nutritional information includes dietary information obtained by the manufacturer of products purchased using the loyalty card.

5. The method of claim 1, further comprising identifying at least one product that compensates for deficiencies.

6. The method of claim 5, further comprising customizing a meal, a product, or a combination of products to compensate for deficiencies.

7. The method of claim 6, further comprising generating a shopping list, item location, and availability.

8. A computer-readable medium encoded with a computer program code for managing nutrition planning data, the program code causing a computer to execute a method comprising:
controlling a first database, a second database, and a third database with a central processor;
storing in the first database a plurality of records comprising loyalty card data for a loyalty card profile;
storing in the second database a plurality of records comprising product information of products purchased using the loyalty card profile;
storing in a third database a plurality of records comprising nutritional intake guidelines;
generating a report by aggregating data from the second database with the loyalty card profile found in the first database;
comparing the report with the nutritional intake guidelines; and
sending the results of the comparison of the report and nutritional intake guidelines.

9. The method of claim 8, wherein the report is sent through an Internet connection, a web browser, or through electronic mail.

10. The method of claim 8, wherein the nutritional intake guidelines are the Food and Drug Administration recommended daily allowance or the U.S. Department of Agriculture Dietary Guidelines.

11. The method of claim 9, further comprising providing a listing of products or meals that will compensate for any deficiencies in nutritional intake.

12. The method of claim 11, further comprising generating a shopping cart listing items to prepare provided meals.

13. A system for managing nutritional plan data, the system comprising:
a database coupled to a central processor;
a storage module configured to store in the database a plurality of records comprising a purchase record of products purchased with a loyalty card and nutritional information for products available for purchase with the loyalty card;
a data processing module configured to compare the purchase record of products purchased with the loyalty card with the nutritional information for products available for purchase with the loyalty card, determine if deficiencies are present according to a standardized measurement, and propose products which compensate for the deficiencies; and
an output module for transmitting results from the central processor, wherein the central processor is configured to receive a request for nutritional information regarding the purchase record of products purchased with the loyalty card and generate a report based upon the deficiencies determined by the data processing module.

14. The system of claim 13, wherein the loyalty card data comprises a user defined loyalty card profile.

15. The system of claim 13, wherein the report is transmitted over an internet connection.

16. The system of claim 13, further comprising a module for creating customized reports.

17. The system of claim 14, further comprising a street map module for locating physical stores.

18. The system of claim 14, further comprising a local store mapping module for locating items within physical stores.

19. The system of claim 18, further comprising a preparation module for providing methods of preparing products purchased with the loyalty card.

20. The system of claim 13, further comprising an alternatives module for providing alternatives to products purchased with the loyalty card.
